(19) United States
(12) Patent Application Publication
(10) Pub. No.: US 2025/0375713 A1
(43) Pub. Date: Dec. 11, 2025

(54) SYSTEMS AND METHODS FOR RESPONSIBLE GAMING USING AUTOMATED PLAYER ALCOHOL LEVEL DETECTION

(71) Applicant: IGT, Las Vegas, NV (US)

(72) Inventors: Michael Russ, Graz (AT); David Froy, Lakeville-Westmorland (CA); Soheil Latifi, Brampton (CA)

(21) Appl. No.: 18/735,469

(22) Filed: Jun. 6, 2024

(51) Int. Cl. A63F 13/79; A63F 13/69; A63F 13/212; A63F 13/213

(52) U.S. Cl. CPC A63F 13/79; A63F 13/69; A63F 13/212; A63F 13/213

(57) ABSTRACT

Embodiments of the present disclosure are directed to responsible gaming features in a gaming venue and more particularly to providing responsible gaming features based on automated detection of a player’s level of intoxication determined from a variety of different inputs and models of player characteristics. Embodiments can utilize different technologies which each (or in combination) accurately measure a solitarily playing player’s Blood Alcohol Concentration (BAC), just by analyzing the player, i.e., touchless and without physical sample-taking. This can be based on audio, video, and other input related to the player. If a determination is made that the player is intoxicated, any number of responsible gaming actions can be initiated.

### BACKGROUND

The present disclosure is generally directed to responsible gaming features in a gaming venue and more particularly to providing responsible gaming features based on automated detection of a players level of intoxication.

Responsible Gaming (RG) is an important aspect in the gaming industry to prevent unhealthy play behavior such as players overspending their play budget. Many initiatives have been established to support RG, such as setting wager thresholds or being observed by casino staff. Those, however, require either the player and/or operator to initially set the thresholds and/or require manual efforts to be identified or triggered.

Current implementations of RG measures are often insufficient as RG actions are triggered based on such as (a) manually when casino staff detects inappropriate behavior, or (b) self-set gaming limits, or (c) asking the player questions / teaching the player about their current play behavior. These mean either manual efforts for the casino staff and/or the player, and/or are based on rudimentary rules/logic, resulting in low efficiency. Another issue, with a patron at an EGM may be served by multiple servers where someone at a bar would normally be served by a single bartender. So, it is hard for a server to keep track of how much alcohol a client is intaking. Hence there is a need in the art for improved systems and methods for providing RG features in a gaming environment.

Embodiments of the present disclosure are directed to responsible gaming features in a gaming venue and more particularly to providing responsible gaming features based on automated detection of a player’s level of intoxication determined from a variety of different inputs and models of player characteristics. According to one embodiment, a method for providing responsible gaming features within a gaming venue can comprise maintaining a trained model of player characteristics, the player characteristics indicating a level of intoxication of an individual. A player profile for a player of an electronic game in the gaming venue can also be maintained. The player profile can comprise a set of predefined responsible gaming setting. A plurality of inputs can be received from a gaming system of the gaming venue. The plurality of inputs can indicate characteristics of the player of the electronic game while playing the electronic game. For example, the plurality of inputs from the gaming system can comprise any of an audio input representing speech characteristics of the player, a video input representing visual characteristics of the player, a breath analysis input, game play information representing action of the player in the electronic game, and/or others.

A Blood Alcohol Concentration (BAC) level for the player can be estimated based on the trained model of player characteristics and the received plurality of inputs from the gaming system. A determination can be made as to whether to apply a responsible gaming action based on the estimated BAC level for the player and the player profile for the player. In response to determining to apply the responsible gaming action, the responsible gaming action can be initiated. For example, the responsible gaming action can comprise a responsible gaming feature of the gaming system. Additionally, or alternatively, the responsible gaming action comprises an electronic message to the player. In some cases, the responsible gaming action can additionally, or alternatively, comprise an electronic notification to gaming venue personnel.

According to another embodiment, a responsible gaming system can comprise a processor and a memory coupled with and readable by the processor. The processor can store therein a set of instructions which, when executed by the processor, causes the processor to maintain a trained model of player characteristics. The player characteristics can indicate a level of intoxication of an individual. The instructions can further cause the processor to maintain a player profile for a player of an electronic game in the gaming venue. The player profile can comprise a set of predefined responsible gaming setting.

The instructions can further cause the processor to receive a plurality of inputs from a gaming system of the gaming venue, the plurality of inputs indicating characteristics of the player of the electronic game while playing the electronic game, estimate a Blood Alcohol Concentration BAC level for the player based on the trained model of player characteristics and the received plurality of inputs from the gaming system, determine whether to apply a responsible gaming action based on the estimated BAC level for the player and the player profile for the player, and in response to determining to apply the responsible gaming action, initiate the responsible gaming action. For example, the plurality of inputs from the gaming system can comprise any of an audio input representing speech characteristics of the player, a video input representing visual characteristics of the player, a breath analysis input, game play information representing action of the player in the electronic game, and/or others. For example, the responsible gaming action can comprise a responsible gaming feature of the gaming system. Additionally, or alternatively, the responsible gaming action comprises an electronic message to the player. In some cases, the responsible gaming action can additionally, or alternatively, comprise an electronic notification to gaming venue personnel.

According to yet another embodiment, a system can comprise a communication network, a gaming system coupled with the communication network, and a responsible gaming system coupled with the communication network. The responsible gaming system comprising a processor and a memory coupled with and readable by the processor and storing therein a set of instructions which, when executed by the processor, causes the processor to maintain a trained model of player characteristics, the player characteristics indicating a level of intoxication of an individual and maintain a player profile for a player of an electronic game in the gaming venue, the player profile comprising a set of predefined responsible gaming setting.

The instructions can further cause the processor to receive a plurality of inputs from a gaming system of the gaming venue, the plurality of inputs indicating characteristics of the player of the electronic game while playing the electronic game, estimate a BAC level for the player based on the trained model of player characteristics and the received plurality of inputs from the gaming system, determine whether to apply a responsible gaming action based on the estimated BAC level for the player and the player profile for the player, and in response to determining to apply the responsible gaming action, initiate the responsible gaming action. For example, the responsible gaming action can comprise a responsible gaming feature of the gaming system. Additionally, or alternatively, the responsible gaming action comprises an electronic message to the player. In some cases, the responsible gaming action can additionally, or alternatively, comprise an electronic notification to gaming venue personnel.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which various embodiments of the present disclosure may be implemented.

FIG. 2 is a block diagram illustrating additional details of components of an exemplary gaming system according to one embodiment of the present disclosure.

FIG. 3 is a block diagram illustrating additional details of components of an exemplary responsible gaming server according to one embodiment of the present disclosure.

FIG. 4 is a flowchart illustrating an exemplary process for providing responsible gaming features according to one embodiment of the present disclosure.

FIG. 5 is a flowchart illustrating an exemplary process for determining whether to apply responsible gaming features according to one embodiment of the present disclosure.

FIG. 6 is a flowchart illustrating an exemplary process for initiating responsible gaming actions according to one embodiment of the present disclosure.

### DETAILED DESCRIPTION

Embodiments of the present disclosure are directed to responsible gaming features in a gaming venue and more particularly to providing responsible gaming features based on automated detection of a player’s level of intoxication determined from a variety of different inputs and models of player characteristics. Embodiments can utilize different technologies which each (or in combination) accurately measure a solitarily playing player’s Blood Alcohol Concentration (BAC), just by analyzing the player, i.e., touchless and without physical sample-taking. This can be based on audio, video, and other input related to the player. If a determination is made that the player is intoxicated, any number of responsible gaming actions can be initiated.

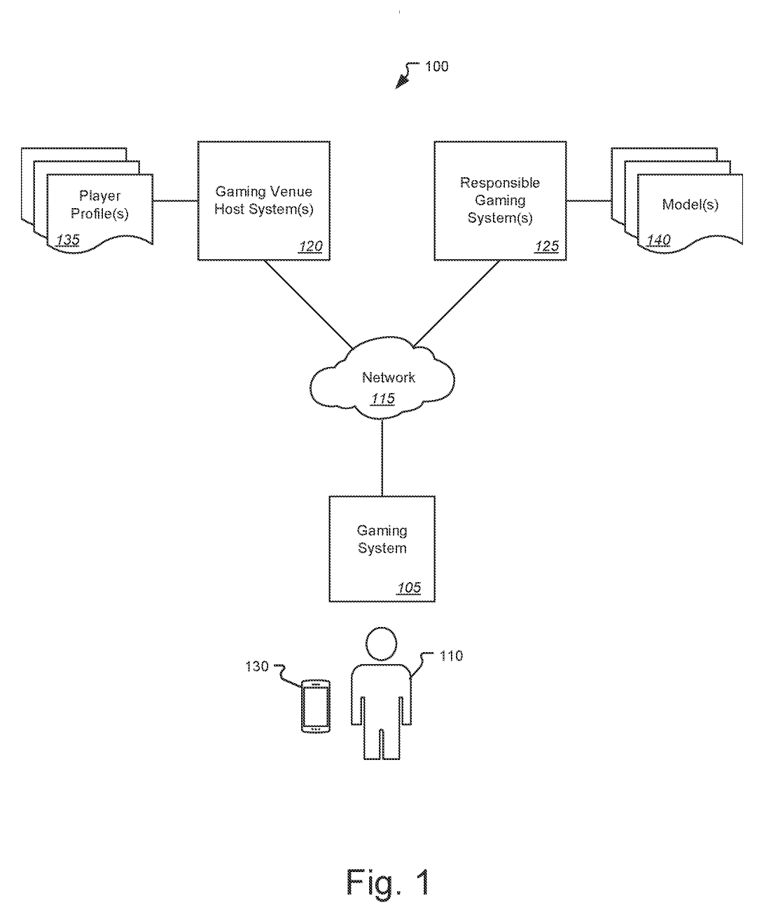

FIG. 1 is a block diagram illustrating an exemplary environment in which various embodiments of the present disclosure may be implemented. As illustrated in this example, the environment 100 can comprise a gaming system 105 such as any Electronic Gaming Machine (EGM), kiosk, or similar gaming system as may be found in a casino or other gaming venue. The gaming system 105 can execute any of a variety of electronic games including, but not limited to slots, video slots, video poker, keno, etc. to be player by a player 110. The gaming system 105 can be coupled with a communication network 115. The communication network 115 can comprise any one or more wired and/or wireless, local-area and/or wide-area networks as known in the art including, but not limited to, the Internet.

Also coupled with the communication network 115 can be one or more gaming venue host systems 120 and a responsible gaming system 125. The gaming venue host system 120 can comprise any one or more servers and/or other computing devices such as commonly used to manage gaming systems 105 and other systems in a casino or other gaming venue. For example, the gaming venue host system 120 can maintain one or more player profiles 135 and/or other information related to players in the gaming venue. Similarly, the responsible gaming system 125 can comprise one or more servers and/or other computing devices as known in the art and used to provide responsible gaming oversight and functions within the gaming venue. It should be noted that, while shown and described separately here, the gaming venue host system(s) and responsible gamin system(s) may be implemented on the same one or more physical and/or virtual machines.

Embodiments of the present disclosure are directed to responsible gaming features in a gaming venue and more particularly to providing responsible gaming features based on automated detection of a player’s level of intoxication determined from a variety of different inputs and models of player characteristics. According to embodiments of the present disclosure, no manual responsible gaming efforts are required by the casino staff, nor are they only based on theoretical assumptions but instead on measures of a player’s condition, in real-time. Personal limits still may or may not be set by the player, e.g., to set “when I’m drunk set my Max. Bet to 100 credits.” In addition, machine learning algorithms can be used to ensure high accuracy of auto-detected intoxication. Finally, the responsible gaming system 125 can also approve sobering out status, automatically.

General speaking, the responsible gaming system 125 can implement player tracking linked to player’s drink behavior and history and associated with opt-in/opt-out status of the BAC detection system program, real-time or near real-time information about the player’s current BAC, personal responsible gaming limits/limitations, number of drunkenness incidents in the past, how many drinks the player ordered in the last X hours, etc.

For example, the responsible gaming system 125 can perform voice analyses using a voice-based deep learning algorithm to detect a player’s BAC level. Audio including the player’s voice can be collected from a variety of sources including, but not limited to, microphones to record voice-based input, such as a microphone integrated into the gaming system 105, microphones at various locations in the casino, e.g., entrance, kiosk, terminal, bar, etc., a microphone of a connected mobile device 130, and others.

In another example, pupil analyses can be performed using visual-based algorithms to detect a player’s BAC level. For example, an optical scanner device can be used to record pupil behavior/movement. This device can comprise a scanner in the gaming system 105, a scanner at various locations in the casino, e.g., entrance, kiosk, terminal, bar, etc., a scanner, i.e., camera, of a connected mobile device, etc.

In yet another example, breath analyses may be use alcoholometer/breath analyzer devices to analyze the player’s breath. Such a device may be integrated into the gaming system 105 or installed at various locations in the casino, e.g., entrance, kiosk, terminal, bar, etc.

According to one embodiment, game play analysis can also be used by the responsible gaming system 125 to determine a player’s BAC level. For example, player reaction time during game play may be used to try to detect BAC of the user. Other actions that can be used can include, but are not limited to, accuracy of touch screen events, time between when a user is prompted to time to interact with the EGM to actual action, multiple touch events leading to choose being made, miss touch events tracked, duration of touch events, from start to when the user lifts finger, touch events where the user moves finger instead of just a press, e.g., moving finger and sliding into the touch area to be pressed, repeated events where touch screen is pressed multiple times, trying to get an action to happen, and others.

Deep learning models 140 used by the responsible gaming system 125 can identify intoxication levels based on multiple inputs such as a player's pupil movement at playtime, and voice-based inputs. The players at playtime are not aware of this monitoring system so their gambling experience will not be halted. These models 140 only use video samples of the players playing with the machine that can be collected with a cam recorder. The players are ensured that the samples will only be used for monitoring and will be deleted on the go.

Similar models can be used to detect intoxication levels based on a short, few second long voice sample, meaning that if the machine is equipped with voice to command modules, the player commands to the machine can be easily used to check if they are in an intoxicated state.

It is also possible to gather playing data belonging to known intoxicated players and known sober players and train a model 140 with it so that at playtime a player can be constantly checked for intoxication. This can also be easy because intoxication has a direct effect on the players behavior.

In one implementation, microphones integrated into the gaming system 105 can be used to continuously measure players’ alcohol level via sound/speech. This can also be used to continuously measure their alcohol level change over time, in order to identify drinking speed and enable prediction of when a threshold will be exceeded. Drinking action can be detected by detecting sounds indicating when the player is drinking a beverage as well as placing the beverage down by audio cues.

According to one embodiment, these processes can be applied to online casinos as well, as most mobile devices and personal computers are equipped with a microphone. Additionally, or alternatively, the processes can be applied to any other devices within a physical gaming venue that are not equipped with a microphone, e.g., EGMs without mic, table games, electronic table games, poker sessions, etc., by using a mobile device instead to verify.

Players frequently connect their mobile device 130 to a gaming system 105, e.g., an EGM for such as using cashless pay, player tracking, phone charging, and others. In addition to an anyways already connected device, the mobile device 130 could also be used to measure BAC via voice and would not require microphones built into the gaming system 105. In other implementations, the player might be asked by the gaming system 105 to connect a mobile device to measure their BAC, e.g., when gaming system 105 are not equipped with a microphone. In some cases, this measure might be triggered by the gaming system 105 if high BAC level has been identified on another machine and associated with the player tracking ID and the current machine is not equipped with a microphone.

According to one embodiment, terminals can be installed in the casino, instead of or in addition to integrating microphones into gaming systems, to which a player has to talk, e.g., read what’s shown on the screen, in order to verify that their BAC status is good. Then, the visitor might be required to insert their player tracking card (or similar device) to store BAC status analysis record associated to their player ID.

In some cases, a BAC level threshold can be set to be eligible for playing. These thresholds can be set by the casino or gaming venue operator, by regulations, etc. Once the threshold is exceeded, responsible gaming measures can be triggered automatically by the gaming system 105. In other cases, automated measures can be triggered on the gaming system 105, i.e., the gaming system 105 could trigger the measure directly, for example, when a player already identified as intoxicated cards into the gaming system. For manual measures, i.e., requiring casino staff to interfere, a warning message could be sent via the casino system to appropriate staff members.

Once BAC level is identified for a certain player, triggered RG measures status might be associated with the player (using player tracking), so that the same measures are applied at other machines in the venue. Once the player’s BAC is known, the system can then predict for how long the player will be too intoxicated to play. In some cases, sobering out via a time estimate can be the basis of disabling or removing responsible gaming measures or it might be preferred to not only rely on estimated time but require a re-measuring of the player’s voice again. For example, this can be accomplished by asking the player to talk to the gaming system, either actively or as a hidden mechanism, in order to ensure BAC identification. Prompts can be presented such as “Activate this feature with your voice,” “Read what’s written on the screen,” “Use your voice to …,” or anything that would require the player to talk to the gaming system.

In some cases, once the BAC level threshold is exceeded, the player may be entirely blocked from any gambling activities. In other cases, the responsible gaming measures can enable free to play or demo mode on the gaming system if the BAC level threshold is exceeded. In yet other cases, various high risk or high wager features may be disabled for the intoxicated player.

According to one embodiment, various game features can be enabled/disabled depending on multiple BAC level thresholds, e.g., BAC level 1: all features enabled, BAC level 2: features X, Y disabled, BAC level 3: features X, Y, Z disabled, etc. This can, in some cases, include disabling cash-in/ticket redemption if a player’s BAC level hits a high enough threshold. Additionally, or alternatively, if the player remains sober throughout the entire visit, no money threshold is set. However, if the player consumes alcohol and a certain BAC level threshold is exceeded, there might be a maximum amount set for money spent throughout the casino visit. According to one embodiment, this maximum can be defined by the player. In another cases, it can be defined by the operator of the gaming venue, e.g., “Above a BAC level 2, the casino visit’s max. money spend is $ 10,000.”

According to one embodiment, an opt-in/opt-out feature can be provided for players where they could volunteer to be part of the BAC detection program or not. For example, BAC detection can run continuously without the player knowing. One a player is detected as intoxicated the first time, a prompt can be shown on screen that explains the BAC detection program and asks the player if they want to participate. In another case, the responsible gaming system can trigger the responsible gaming actions automatically when intoxication is detected. When the player returns to the gaming venue the next time, if the player is sober, the responsible gaming system can trigger a prompt that explains what happened and why in the last visit and the asks the player if they want to opt into this feature in the future. In yet another case, when creating a player account at the gaming venue, e.g., at the casino entrance with staff, or directly at a gaming machine, etc., the player could be asked initially if they would like to opt into the feature.

As described herein, a player’s BAC level can be detected using one, some, or all proposed methods in various combination. In some cases, in order to trigger responsible gaming actions, the responsible gaming system might require at least two methods to verify that a player is intoxicate. Conversely, the system might require at least two methods to verify a player’s sober status. In yet another example, intoxication detection might only require one method to trigger responsible gaming but to un-trigger responsible gaming, two methods might be required to prove sobriety.

By applying a casino “Live Chat System,” e.g., a casino-like Discord, using both voice and audio, a comprehensive BAC analysis could be performed by analyzing all mentioned BAC detection methods (voice, pupils, breath). If players communicate with each other in the same casino venue / across multiple venues / worldwide, etc., voice analysis can be performed based on players talking with each other. Also, breath analysis can be performed based on players talking. Pupils analysis can be performed based on video streaming amongst the players.

According to one embodiment, game play data can be used to further detect a player’s BAC level. For example, player reaction time during game play, accuracy of touch screen events, time between when a user is prompted to time to interact with the EGM to actual action, multiple touch events leading to choose being made, miss touch events tracked, duration of touch events, from start to when the user lifts finger, touch events where the user moves finger instead of just a press, moving the finger and sliding into the touch area to be pressed, repeated events where touch screen is pressed multiple times, trying to get an action to happen, and/or others can be used individually or together to estimate a plyer’s BAC level.

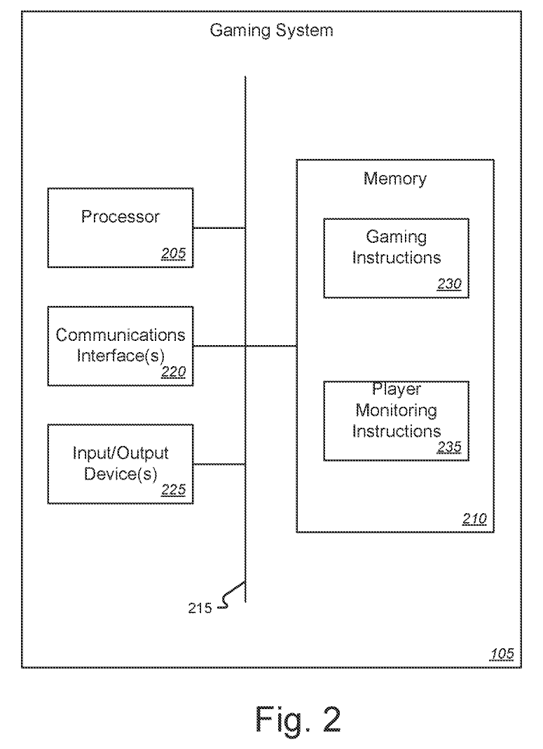

FIG. 2 is a block diagram illustrating additional details of components of an exemplary gaming system according to one embodiment of the present disclosure. As illustrated in this example, a gaming system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 and one or more input/output devices 225 via the communications bus 215. The communication interface(s) 220 can comprise, for example, an Ethernet, Bluetooth, WiFi, cellular, and/or other type of wired and/or wireless communications interface. Via the communication interface(s) 220, the gaming system 105 can communicate with other devices and/or systems through a communications network 115 as described above. The input/output devices 225 can include, but are not limited to a display device such as a Liquid Crystal Display (LCD), Light Emitting Diode (LED), Organic Light Emitting Diode (OLED), or other type of display, a ticket printer, etc. According to one embodiment, the input/output devices 225 can further comprise one or more cameras, microphones, breathalyzers or air sampling devices, etc.

The memory 210 can store therein a set of gaming instructions 230 which, when executed by the processor 205, cause the processor 205 to execute an electronic game. The electronic game can be any of a wide variety of electronic games of chance including, but not limited to, slots, video slots, video poker, keno, blackjack, etc. to be played by a player, e.g., in a casino or other gaming venue.

The memory can also store therein a set of player monitoring instructions 235 which, when executed by the processor 205 can cause the processor 205 to ready video, audio, and/or other inputs from the input devices 225 and provide the input(s) to the responsible gaming system 125 via the communications interface 220. Additionally, or alternatively, the player monitoring instructions 235 can cause the processor 205 to monitor player actions in the electronic game and provide information related to those activities to the responsible gaming system 125 via the communications interface 220.

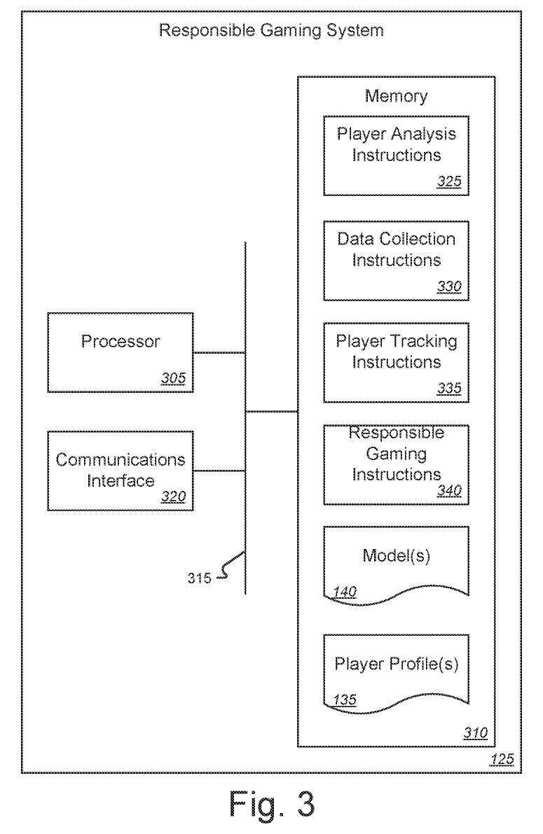

FIG. 3 is a block diagram illustrating additional details of components of an exemplary responsible gaming system according to one embodiment of the present disclosure. As illustrated in this example, a responsible gaming system 125 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320. The communication interfaces 320 can comprise, for example, an Ethernet, Bluetooth, WiFi, cellular, and/or other type of wired and/or wireless communications interface.

The memory 310 can store therein a set of game management instructions 330 which, when executed by the processor 305, cause the processor 305 to maintain one or more trained models 140 of player characteristics. The player characteristics can include, but are not limited to, speech characteristics, eye movement characteristics, expression, posture, and/or movement characteristics, game player characteristics such as decision making, reaction time and/or ability, etc., and/or others, indicating a level of intoxication of an individual. A player profile 135 for a player 110 of an electronic game in the gaming venue can also be maintained in the memory 210 of the responsible gaming system 125 or elsewhere accessible via the communications interface 320. The player profile 135 can comprise a set of predefined responsible gaming setting for the player including, but not limited to, an opt-in or opt-out setting, preferences for implementing responsible gaming features, etc.

The memory 310 can also store therein a set of data collection instructions 330 and/or player tracking instructions 335 which, when executed by the processor 205, can cause the processor 305 to receive a plurality of inputs from a gaming system 105 of the gaming venue. The plurality of inputs can indicate characteristics of the player 110 of the electronic game while playing the electronic game. For example, the plurality of inputs from the gaming system 105 can comprise any of an audio input representing speech characteristics of the player 110, a video input representing visual characteristics of the player 110, e.g., expressions, eye, face, and/or body movements, reactions, etc., a breath analysis input, game play information representing action of the player 110 in the electronic game, and/or others.

The player analysis instructions 325 can further cause the processor to estimate a BAC level for the player 110 based on the trained model(s) 140 of player characteristics and the received plurality of inputs from the gaming system 105 and make a determination as to whether to apply a responsible gaming action based on the estimated BAC level for the player 110 and the player profile 135 for the player 110. In response to determining to apply the responsible gaming action, player analysis instructions 325 can cause the processor to initiate the responsible gaming action.

The memory 310 can also have stored therein a set of responsible gaming instructions 340 which, when executed by the processor 305, can cause the processor 305 to determine whether to apply responsible gaming features. Determining whether to apply responsible gaming features can comprise determining, e.g., based on the player profile 135, whether the player 110 has opted in or, conversely, opted out of responsible gaming features. In response to determining that the player 110 has opted in, or has not opted out, a further determination can be made as to whether the player’s BAC level exceeds a predefined threshold value. This threshold can be set, for example, by an owner or operator of a gaming venue in which the gaming system 105 is installed, by a regulatory agency for a jurisdiction in which the gaming system 105 is installed, etc. In response to determining the player’s BAC level exceeds the threshold level, the responsible gaming instructions 340 can cause the processor 305 to select one or more responsible gaming actions to be implemented. These selections can be made based on preferences defined in the player profile 135. For example, the player may define a preference to receive message via a mobile device 130 suggesting that it is time to take a break. On other cases, the preferences may be for implementation of a responsible gaming feature of the gaming system 105 such as limiting bets etc.

The responsible gaming instructions 340 can cause the processor 305 to initiate the selected actions. For example, the responsible gaming action can comprise triggering a responsible gaming feature of the gaming system, e.g., limiting bets, slowing play, entering a demo mode, etc. Additionally, or alternatively, the responsible gaming action can comprise sending an electronic message to the player 110, e.g., through the gaming system 105, the player’s mobile device 130, etc. In some cases, the responsible gaming action can additionally, or alternatively, comprise sending an electronic notification to gaming venue personnel. For example, a notification can be sent to bar and/or wait staff to stop serving the player alcohol for a period of time. Other actions are contemplated and considered to be within the scope of the present disclosure.

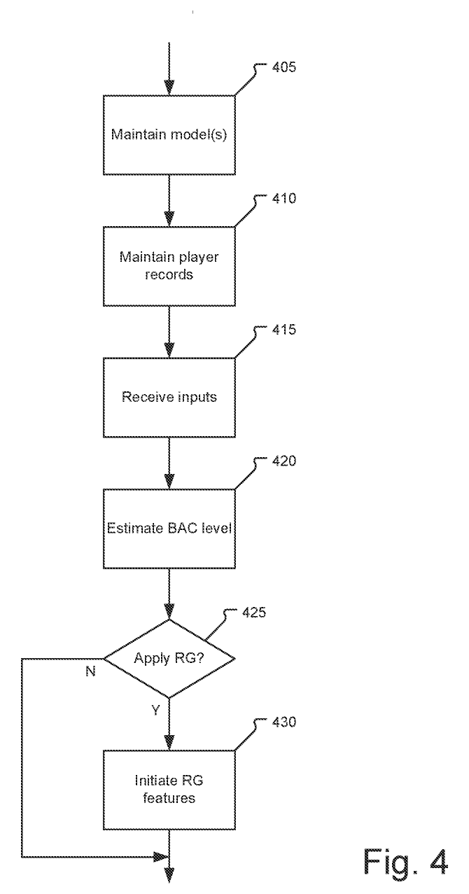

FIG. 4 is a flowchart illustrating an exemplary process for providing responsible gaming features according to one embodiment of the present disclosure. As illustrated in this example, providing responsible gaming features within a gaming venue can comprise maintaining 405 one or more trained models 140 of player characteristics. The player characteristics can include, but are not limited to, speech characteristics, eye movement characteristics, expression, posture, and/or movement characteristics, game player characteristics such as decision making, reaction time and/or ability, etc., and/or others, indicating a level of intoxication of an individual. A player profile 135 for a player 110 of an electronic game in the gaming venue can also be maintained 410. The player profile 135 can comprise a set of predefined responsible gaming setting for the player including, but not limited to, an opt-in or opt-out setting, preferences for implementing responsible gaming features, etc.

A plurality of inputs can be received 415 from a gaming system 105 of the gaming venue. The plurality of inputs can indicate characteristics of the player 110 of the electronic game while playing the electronic game. For example, the plurality of inputs from the gaming system 105 can comprise any of an audio input representing speech characteristics of the player 110, a video input representing visual characteristics of the player 110, e.g., expressions, eye, face, and/or body movements, reactions, etc., a breath analysis input, game play information representing action of the player 110 in the electronic game, and/or others.

A BAC level for the player 110 can be estimated 420 based on the trained model(s) of player characteristics and the received plurality of inputs from the gaming system 105. A determination 425 can be made as to whether to apply a responsible gaming action based on the estimated 420 BAC level for the player 110 and the player profile 135 for the player 110. In response to determining 425 to apply the responsible gaming action, the responsible gaming action can be initiated 430.

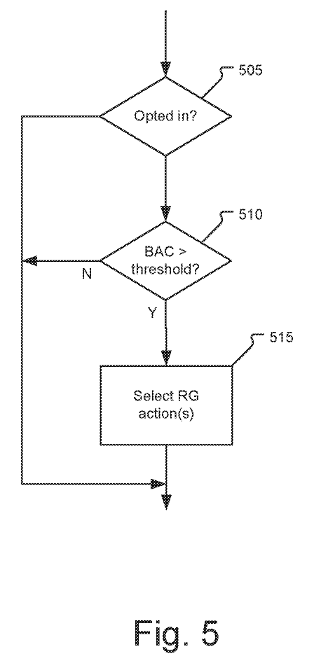

FIG. 5 is a flowchart illustrating an exemplary process for determining whether to apply responsible gaming features according to one embodiment of the present disclosure. As illustrated in this example, determining whether to apply responsible gaming features can comprise determining 505, e.g., based on the player profile 135, whether the player 110 has opted in or, conversely, opted out of responsible gaming features. In response to determining 505 that the player 110 has opted in, or has not opted out, a further determination 510 can be made as to whether the player’s BAC level exceeds a predefined threshold value. This threshold can be set, for example, by an owner or operator of a gaming venue in which the gaming system 105 is installed, by a regulatory agency for a jurisdiction in which the gaming system 105 is installed, etc. In response to determining 510 the player’s BAC level exceeds the threshold level, one or more responsible gaming actions to be implemented can be selected 515. These selections 515 can be made based on preferences defined in the player profile 135. For example, the player may define a preference to receive message via a mobile device 130 suggesting that it is time to take a break. On other cases, the preferences may be for implementation of a responsible gaming feature of the gaming system 105 such as limiting bets etc.

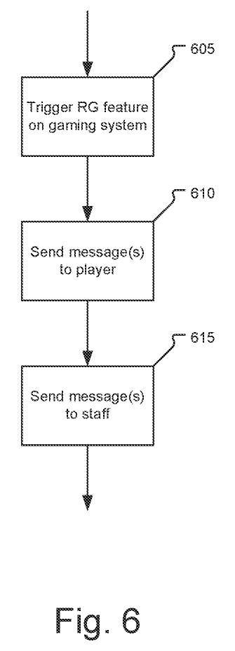

FIG. 6 is a flowchart illustrating an exemplary process for initiating responsible gaming actions according to one embodiment of the present disclosure. As illustrated in this example, the responsible gaming action can comprise triggering 605 a responsible gaming feature of the gaming system, e.g., limiting bets, slowing play, entering a demo mode, etc. Additionally, or alternatively, the responsible gaming action can comprise sending 610 an electronic message to the player 110, e.g., through the gaming system 105, the player’s mobile device 130, etc. In some cases, the responsible gaming action can additionally, or alternatively, comprise sending 615 an electronic notification to gaming venue personnel. For example, a notification can be sent to bar and/or wait staff to stop serving the player alcohol for a period of time. Other actions are contemplated and considered to be within the scope of the present disclosure.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for providing responsible gaming features within a gaming venue, the method comprising:
maintaining, by a processor of a responsible gaming system, a trained model of player characteristics, the player characteristics indicating a level of intoxication of an individual;
maintaining, by the processor of the responsible gaming system, a player profile for a player of an electronic game in the gaming venue, the player profile comprising a set of predefined responsible gaming setting;
receiving, by the processor of the responsible gaming system, a plurality of inputs from a gaming system of the gaming venue, the plurality of inputs indicating characteristics of the player of the electronic game while playing the electronic game;
estimating, by the processor of the responsible gaming system, a Blood Alcohol Concentration (BAC) level for the player based on the trained model of player characteristics and the received plurality of inputs from the gaming system;
determining, by the processor to the responsible gaming system, whether to apply a responsible gaming action based on the estimated BAC level for the player and the player profile for the player; and
in response to determining to apply the responsible gaming action, initiating, by the processor of the responsible gaming system, the responsible gaming action.

2. The method of claim 1, wherein the plurality of inputs from the gaming system comprises an audio input representing speech characteristics of the player.

3. The method of claim 1, wherein the plurality of inputs from the gaming system comprises a video input representing visual characteristics of the player.

4. The method of claim 1, wherein the plurality of inputs from the gaming system comprises a breath analysis input.

5. The method of claim 1, wherein the plurality of inputs from the gaming system comprises game play information representing action of the player in the electronic game.

6. The method of claim 1, wherein the responsible gaming action comprises a responsible gaming feature of the gaming system.

7. The method of claim 1, wherein the responsible gaming action comprises an electronic message to the player.

8. The method of claim 1, wherein the responsible gaming action comprises an electronic notification to gaming venue personnel.

9. A responsible gaming system comprising:
a processor; and
a memory coupled with and readable by the processor and storing therein a set of instructions which, when executed by the processor, causes the processor to:
maintain a trained model of player characteristics, the player characteristics indicating a level of intoxication of an individual;
maintain a player profile for a player of an electronic game in the gaming venue, the player profile comprising a set of predefined responsible gaming setting;
receive a plurality of inputs from a gaming system of the gaming venue, the plurality of inputs indicating characteristics of the player of the electronic game while playing the electronic game;
estimate a Blood Alcohol Concentration (BAC) level for the player based on the trained model of player characteristics and the received plurality of inputs from the gaming system;
determine whether to apply a responsible gaming action based on the estimated BAC level for the player and the player profile for the player; and
in response to determining to apply the responsible gaming action, initiate the responsible gaming action.

10. The responsible gaming system of claim 9, wherein the plurality of inputs from the gaming system comprises an audio input representing speech characteristics of the player.

11. The responsible gaming system of claim 9, wherein the plurality of inputs from the gaming system comprises a video input representing visual characteristics of the player.

12. The responsible gaming system of claim 9, wherein the plurality of inputs from the gaming system comprises a breath analysis input.

13. The responsible gaming system of claim 9, wherein the plurality of inputs from the gaming system comprises game play information representing action of the player in the electronic game.

14. The responsible gaming system of claim 9, wherein the responsible gaming action comprises a responsible gaming feature of the gaming system.

15. The responsible gaming system of claim 9, wherein the responsible gaming action comprises an electronic message to the player.

16. The responsible gaming system of claim 9, wherein the responsible gaming action comprises an electronic notification to gaming venue personnel.

17. A system comprising:
a communication network;
a gaming system coupled with the communication network; and
a responsible gaming system coupled with the communication network, the responsible gaming system comprising a processor and a memory coupled with and readable by the processor and storing therein a set of instructions which, when executed by the processor, causes the processor to:
maintain a trained model of player characteristics, the player characteristics indicating a level of intoxication of an individual;
maintain a player profile for a player of an electronic game in the gaming venue, the player profile comprising a set of predefined responsible gaming setting;
receive a plurality of inputs from a gaming system of the gaming venue, the plurality of inputs indicating characteristics of the player of the electronic game while playing the electronic game;
estimate a Blood Alcohol Concentration (BAC) level for the player based on the trained model of player characteristics and the received plurality of inputs from the gaming system;
determine whether to apply a responsible gaming action based on the estimated BAC level for the player and the player profile for the player; and
in response to determining to apply the responsible gaming action, initiate the responsible gaming action.

18. The system of claim 17, wherein the responsible gaming action comprises a responsible gaming feature of the gaming system.

19. The system of claim 17, wherein the responsible gaming action comprises an electronic message to the player.

20. The system of claim 17, wherein the responsible gaming action comprises an electronic notification to gaming venue personnel.
